(19) United States
(12) Patent Application Publication
(10) Pub. No.: US 2013/0038039 A1
(43) Pub. Date: Feb. 14, 2013

(54) VEHICLE

(71) Applicant: Alistaire J. McGuffie, Charters Towers (AU)

(72) Inventor: Alistaire J. McGuffie, Charters Towers (AU)

(21) Appl. No.: 13/568,547

(22) Filed: Aug. 7, 2012

(30) Foreign Application Priority Data
Aug. 11, 2011 (AU) 2011903216

(51) Int. Cl. B62D 12/00; B62D 5/12

(52) U.S. Cl. 280/458

(57) ABSTRACT

A vehicle having a first chassis and a second chassis movable relative to the first chassis includes a mechanism configured for moving the first chassis relative to the second chassis. The mechanism includes first and second connecting members, each connecting member connecting one side of the first chassis with an opposite side of the second chassis, and each connecting member being pivotable relative to the first or second chassis to allow the first chassis to move relative to the second chassis in a first direction about a point on a first side of the second chassis and in a second direction about a point on a second side of the second chassis.

### CROSS REFERENCE TO RELATED APPLICATION

Not applicable.

### FEDERALLY SPONSORED RESEARCH OR DEVELOPMENT

Not applicable.

### BACKGROUND

This disclosure relates generally to the field of vehicles.

Tractors and other types of vehicles, such as articulated vehicles and skid loaders, are used in agriculture and construction works. To be more effective, such vehicles typically require increased maneuverability.

Tractors, for example, are fitted with smaller front wheels compared to rear wheels for increased maneuverability. Articulated vehicles typically require a longer wheelbase between the front and rear wheels or smaller wheels to be more maneuverable. Some vehicles with short wheelbases, such as skid loaders, employ skidded steering for increased maneuverability, which can damage the ground as well as the tires.

Embodiments of the invention provide a vehicle which provides increased maneuverability, overcomes or ameliorates one or more of the disadvantages or problems described above, or which at least provides the consumer with a useful or commercial choice.

It will be clearly understood that any reference herein to background material or information, or to a prior publication, does not constitute an admission that any material, information or publication forms part of the common general knowledge in the art, or is otherwise admissible prior art, whether in Australia or in any other country.

### SUMMARY

According to one aspect of the invention, there is provided a vehicle comprising:
a. a first chassis;
b. a second chassis movable relative to the first chassis; and
c. moving means for moving the first chassis relative to the second chassis;
d. the moving means comprising first and second connecting members, each connecting member connecting one side of the first chassis with an opposite side of the second chassis, and each connecting member being pivotable relative to the first or second chassis to allow the first chassis to move relative to the second chassis in a first direction about a point on a first side of the second chassis and in a second direction about a point on a second side of the second chassis.

Advantageously, the connecting members enable the vehicle to be more maneuverable. In particular, the connecting members allow the first and second chassis to be freely movable with respect to one another such that the vehicle can easily move around tight bends and corners. An additional benefit is that steering slip may be reduced, typically resulting in less wear on tires and the ground.

Each connecting member may be configured to be pivotable only relative to a respective one of the first or second chassis when the first chassis moves in the first direction or the second direction.

The first connecting member may connect a first side of the first chassis to the second side of the second chassis opposite the first side of the first chassis, and the second connecting member may connect a second side of the first chassis to the first side of the second chassis opposite the second side of the first chassis.

Typically, the connecting members are each disposed generally transversely between the first chassis and the second chassis with respect to a direction of travel along a straight path. Further, the first connecting member may be disposed above the second connecting member. In addition, the connecting members may be non-extendable elongate members.

In one embodiment, the connecting members are pivotably connected to the first and second chassis by kingpins. The first connecting member may be pivotable about a first kingpin adjacent the second side of the second chassis to allow the first chassis to rotate about the first kingpin and move in the second direction relative to the second chassis. Similarly, the second connecting member may be pivotable about a second kingpin adjacent the first side of the second chassis to allow the first chassis to rotate about the second kingpin and move in the first direction relative to the second chassis.

The moving means may further comprise actuating means for moving the first chassis relative to the second chassis. The actuator means may be adapted to change the angle between the first and second chassis to thereby steer the vehicle.

Moreover, hydraulic cylinders may be used to push and/or pull the first chassis relative to the second chassis to change the angle therebetween. In particular, one hydraulic cylinder may be located between a first side of the first chassis and the first side of the second chassis and another hydraulic cylinder may be located between a second side of the first chassis and the second side of the second chassis to thereby move the first chassis relative to the second chassis. The hydraulic cylinders may be double acting hydraulic cylinders.

According to another aspect of the invention, there is provided a vehicle comprising:
a. a first chassis;
b. a second chassis movable relative to the first chassis; and
c. moving means for moving the first chassis relative to the second chassis;
d. the moving means comprising first and second connecting members, each connecting member connecting one side of the first chassis with an opposite side of the second chassis, and each connecting member being pivotable relative to the first or second chassis to allow the first chassis to move relative to the second chassis.

Typically, the first connecting member is pivotable about a first point adjacent one side of the second chassis to allow the first chassis to rotate about the first point and move in one direction relative to the second chassis, and the second connecting member is pivotable about a second point adjacent an opposite side of the second chassis to allow the first chassis to rotate about the second point and move in an opposite direction relative to the second chassis.

According to a further aspect of the invention, there is provided a mechanism for assisting the movement of a vehicle assembly having a first chassis and a second chassis, the mechanism comprising:
a. a first connection member for connecting a first side of the first chassis with a second side of the second chassis opposite the first side of the first chassis, and
b. a second connecting member for connecting a second side of the first chassis with a first side of the second chassis opposite the first side of the first chassis,
c. each connecting member being pivotable relative to the first or second chassis to allow the first chassis to move relative to the second chassis.

Advantageously, the mechanism may be used to assist the movement of vehicle assemblies of any size. For example, the mechanism may be used in small vehicle assemblies having closely aligned adjacent wheels on each side of the vehicle assembly, such as four wheel drives, tractors, bobcats or the like. The mechanism may also be used assist the movement of a vehicle assembly comprising a motor vehicle and a trailer. Further, the mechanism allows the vehicle to easily move around bends and corners without external steering and actuating means such as differential gears and hydraulic rams. Of course, the mechanism may also be used to assist the maneuvering of large vehicles such as trucks or lorries without the need for differential gears between the drive axles. Preferably, actuating means such as hydraulic rams are used to assist the steering of such large vehicles.

Typically, the connection members are connected to the first and second chassis by kingpins. The kingpins may be low friction kingpins. The mechanism may further include bearings to assist movement of the connection members about the kingpins. The roller bearings may be tapered roller bearings.

Further, the connecting members are non-extendable elongate members. The first connecting member may be disposed above the second connecting member.

Any of the features described herein can be combined in any combination with any one or more of the other features described herein within the scope of the invention.

### BRIEF DESCRIPTION OF THE DRAWINGS

One or more preferred embodiments of the invention will now be described, by way of example only, with reference to the accompanying drawings in which:

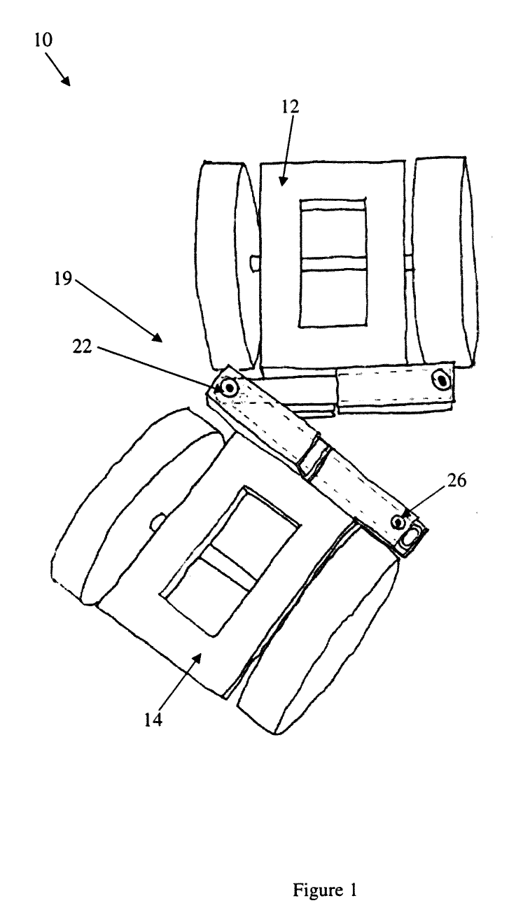

a. FIG. 1 is a top view of a vehicle in accordance with an embodiment of the invention, showing a 45 degree turn in an anti-clockwise direction.

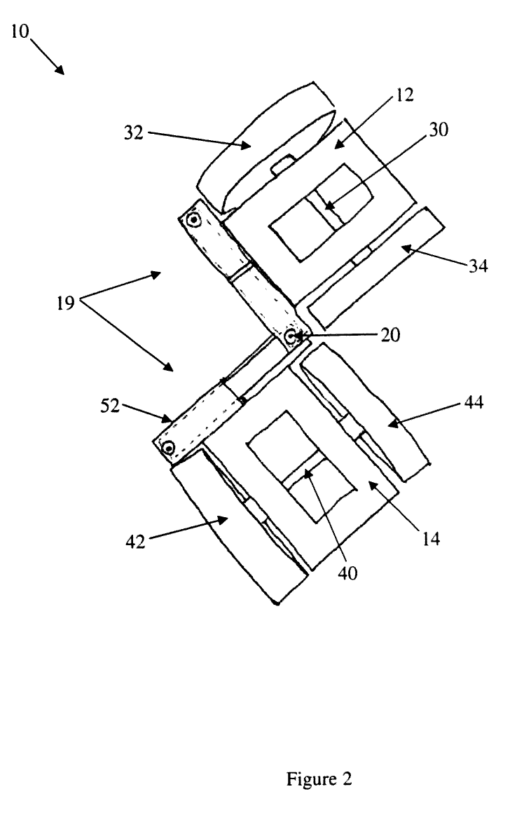

b. FIG. 2 is a top view of a vehicle in accordance with an embodiment of the invention, showing a 90 degree turn in a clockwise direction.

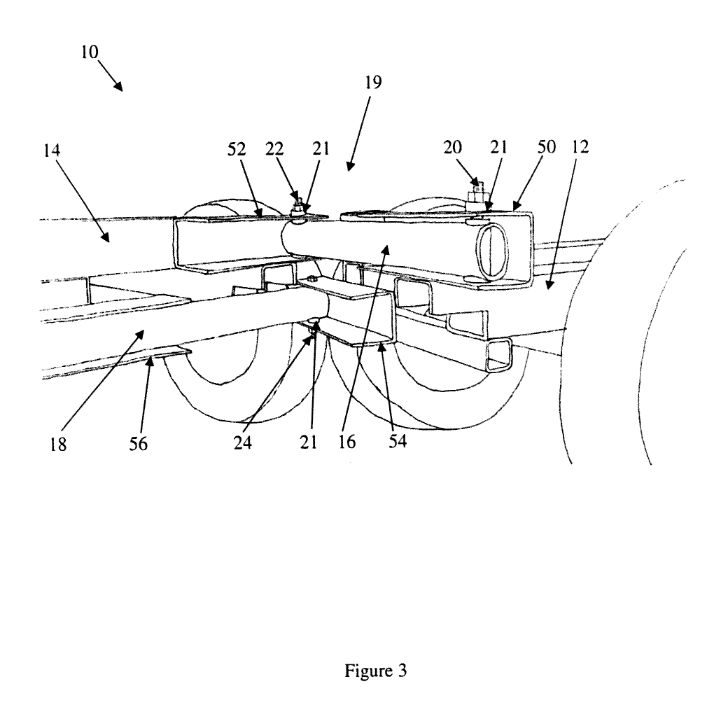

c. FIG. 3 is a partial side view of a vehicle in accordance with an embodiment of the invention, showing a 90 degree turn in an anti-clockwise direction.

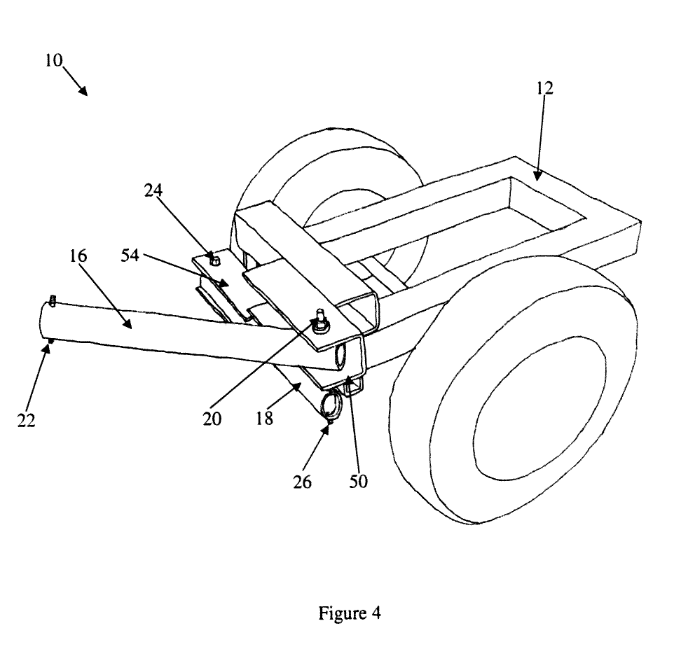

d. FIG. 4 is a perspective view of the vehicle of FIG. 1 with parts of the vehicle removed for additional clarity, showing a 45 degree turn in a clockwise direction.

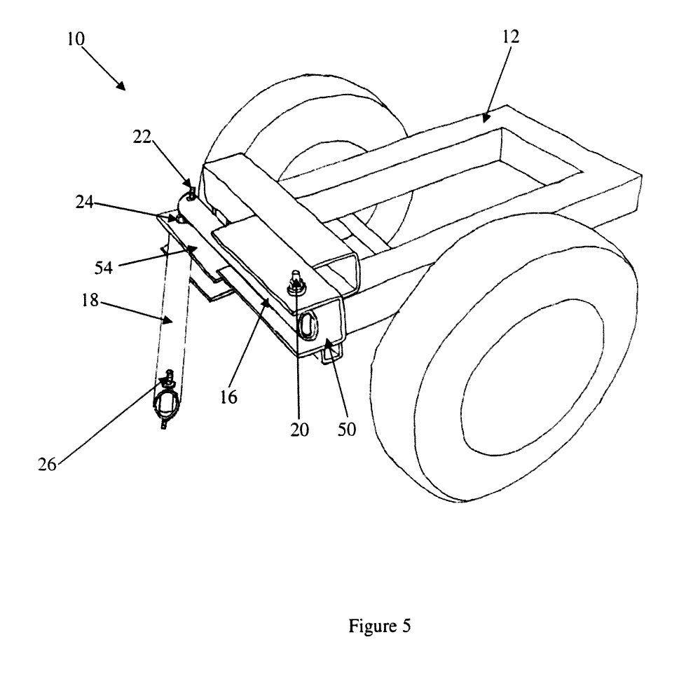

e. FIG. 5 is a perspective view of the vehicle of FIG. 1 with parts of the vehicle removed for additional clarity, showing a 45 degree turn in an anti-clockwise direction.

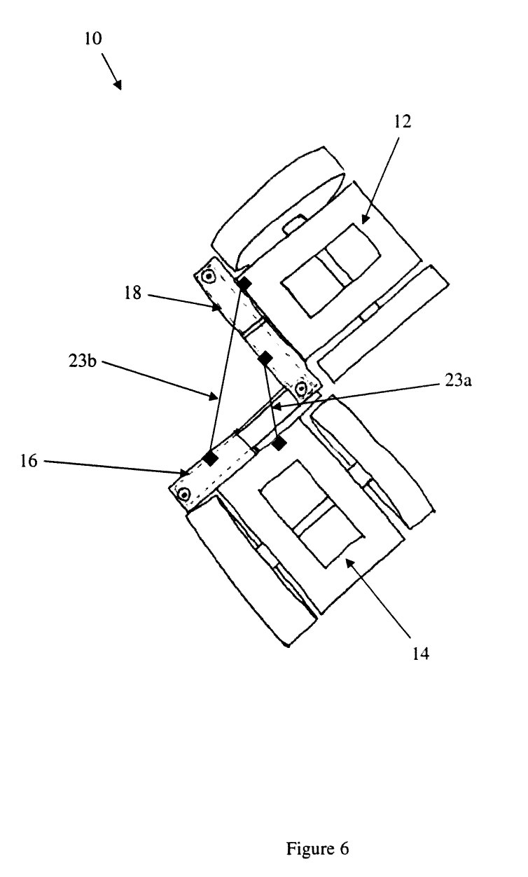

f. FIG. 6 is a schematic top view of the vehicle as shown in FIG. 2 including actuating means according to one embodiment of the invention.

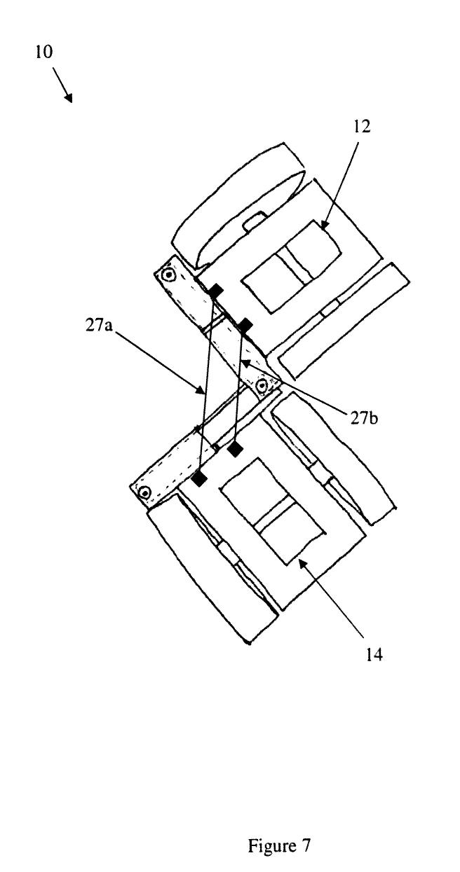

g. FIG. 7 is a schematic top view of the vehicle as shown in FIG. 2 including actuating means according to another embodiment of the invention.

### DETAILED DESCRIPTION OF THE PREFERRED EMBODIMENT

With reference to FIG. 1, there is shown a vehicle 10 turned in an anti-clockwise orientation. The vehicle 10 comprises a front (i.e. first) chassis 12 and a rear (i.e. second) chassis 14. The vehicle further comprises a central moving means 19 for moving the front chassis 12 relative to the rear chassis 14. The moving means 19 is configured so that it can move the front chassis 12 relative to the rear chassis 14 in an anti-clockwise direction about a point in the form of a kingpin 22 on the left side of the vehicle 10. The front chassis 12 is connected to the rear chassis 14 by the moving means 19.

FIG. 2 shows the vehicle 10 turned in a clockwise orientation. The moving means 19 is configured so that it can move the front chassis 12 relative to the rear chassis 14 in a clockwise direction about a point in the form of a kingpin 20 on the right side of the vehicle 10. The front chassis 12 comprises an axle 30. Two wheels 32, 34 are attached to the axle 30. The rear chassis 14 comprises an axle 40. Two wheels 42, 44 are attached to the axle 40.

With reference to FIG. 3, the moving means 19 of the vehicle 10 comprises an upper (i.e. first) connecting member 16 and a lower (i.e. second) connecting member 18 for connecting the front chassis 12 to the rear chassis 14. The upper connecting member 16 is rotatably connected to the front chassis 12 on a right side thereof by a kingpin 20 and is also rotatably connected to the rear chassis 14 on a left side thereof by a kingpin 22. In particular, the upper connecting member 16 is rotatably connected to a U-shaped bracket 50 on the front chassis 12 on a right side thereof and to a U-shaped bracket 52 on the rear chassis 14 on a left side thereof. The lower connecting member 18 is rotatably connected to the front chassis 12 on a left side thereof by a kingpin (24) and is also rotatably connected to the rear chassis 14 on a right side thereof by a kingpin 26 (not shown, best seen in FIG. 1). In particular, the lower connecting member 18 is rotatably connected to a U-shaped bracket 54 on the front chassis 12 on a left side thereof and to a U-shaped bracket 56 on the rear chassis 14 on a right side thereof. The brackets 50, 52 are adapted to provide support to the upper connecting member 16. The brackets 54, 56 are adapted to provide support to the lower connecting member 18. Bearings 21, such as tapered roller bearings, are used in the connection between the connecting members 16, 18 and the kingpins 20, 22, 24, 26 to assist the rotational movement of the connecting members 16, 18 about the kingpins 20, 22, 24, 26.

With reference to FIG. 4, the vehicle 10 is shown with the rear chassis removed to provide a better view of the connecting members 16, 18. The front chassis 12 is orientated at 45° in a clockwise direction relative to the rear chassis 14 (not shown, best seen in FIG. 2). In this orientation, the kingpins 20, 26 are substantially close or aligned (in a vertical direction). The upper connecting member 16 is substantially aligned with bracket 52 (not shown in FIG. 4; best seen in FIG. 3) and the lower connecting member 18 is substantially aligned with bracket 54.

With reference to FIG. 5, the vehicle 10 is shown with the rear chassis removed to provide a better view of the connecting members 16, 18. The front chassis 12 is orientated at 45° in an anti-clockwise direction relative to the rear chassis 14 (not shown in FIG. 5; best seen in FIG. 1). In this orientation, the kingpins 22, 24 are substantially close or aligned (in a vertical direction). Also in this orientation, the upper connecting member 16 is substantially aligned with bracket 50 and the lower connecting member 18 is substantially aligned with bracket 56 (not shown in FIG. 5; best seen in FIG. 3).

In use, the moving means 19 (as seen in FIG. 1) typically comprises actuator means (not shown) to move the front chassis 12 relative to the rear chassis 14.

When the vehicle 10 turns from a straight position (not shown) to the left (as seen in FIGS. 1, 3, 5), the upper connecting member 16 (as seen in FIG. 3) moves relative to the rear chassis 14 about the kingpin 22 and remains substantially motionless relative to the front chassis 12. In addition, the lower connecting member 18 moves relative to the front chassis 12 about the kingpin 24 and remains substantially motionless relative to the rear chassis 14. The upper connecting member 16 is substantially parallel to the bracket 50 on the front chassis 12 and the lower connecting member 18 is substantially parallel to the bracket 56 on the rear chassis 14. Kingpin 24 and kingpin 22 are aligned in a vertical orientation or close to alignment.

When the vehicle 10 turns from a straight position (not shown) to the right (as seen in FIGS. 2, 4), the upper connecting member 16 (as seen in FIG. 4) moves relative to the front chassis 12 about the kingpin 20 and remains substantially motionless relative to the rear chassis 14 (as seen in FIG. 2). In addition, the lower connecting member 18 (as seen in FIG. 4) moves relative to the rear chassis 14 (as seen in FIG. 2) about the kingpin 26 (as seen in FIG. 4) and remains substantially motionless relative to the front chassis 12. The upper connecting member 16 is substantially parallel to the bracket 52 (as seen in FIG. 2) on the rear chassis 14 and the lower connecting member 18 (as seen in FIG. 4) is substantially parallel to the bracket 54 on the front chassis 12. Kingpin 20 and kingpin 26 are aligned in a vertical orientation or close to alignment.

As shown in FIG. 6, the vehicle 10 includes hydraulic rams 23a, 23b as actuating means for assisting the movement between the front and rear chassis 12, 14. A first hydraulic ram 23a is pivotally connected between the front chassis 12 and the upper connecting member 16. A second hydraulic ram 23b is pivotally connected between the rear chassis 14 and the lower connecting member 18.

To move the vehicle 10 in the clockwise direction as shown in FIG. 6, the first hydraulic ram 23a is extended and the second hydraulic ram 23b is retracted. To move the vehicle 10 in an anti-clockwise direction (see FIG. 1), the first hydraulic ram 23a is retracted, and the second hydraulic ram 23h is extended.

In an alternative embodiment as shown in FIG. 7, first and second hydraulic rams 27a, 27b are pivotally connected between the front chassis 12 and the rear chassis 14. To move the vehicle 10 in the clockwise direction as shown in FIG. 7, the first hydraulic ram 27a is extended and the second hydraulic ram 27b is retracted. To move the vehicle 10 in an anti-clockwise direction (see FIG. 1), the first hydraulic ram 27a is retracted and the second hydraulic ram 27b is extended.

In practice, the vehicle in the drawings may also incorporate a number of other components which have not been shown. For example, the vehicle may have a body and “running gear,” such as engine, transmission, driveshaft, differential, suspension and/or the like.

In another embodiment the vertical placement of the connecting members could be interchanged.

In a further embodiment, to increase the maneuverability of the vehicle 10, two sets of moving means 19 may be connected side by side with one another in a cascading arrangement. In this embodiment, the total turning angle between the front and rear chassis 12, 14 would be the sum of the turning angle for each moving means 19. Alternatively, the connection members 16, 18 may be significantly longer than the width of the front and rear chassis 12, 14 such that an end portion of each connection member 16, 18 is connected to an intermediate portion of a side rail disposed on either side of the rear chassis 14. Such arrangements may be particularly suitable for embodiments in which the front chassis 12 forms part of a motorized vehicle such as a car, and the rear chassis 14 forms part of a trailer.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

In the present specification and claims (if any), the word “comprising” and its derivatives including “comprises” and “comprise” include each of the stated integers but does not exclude the inclusion of one or more further integers unless the context of use indicates otherwise.

Reference throughout this specification to “one embodiment”, or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

The invention has been described in language more or less specific to structural or methodical features. It is to be understood that the invention is not limited to specific features shown or described, since the means herein described comprises preferred forms of putting the invention into effect. The invention is, therefore, claimed in any of its forms or modifications within the proper scope of the appended claims.

1. A vehicle comprising:
a first chassis;
a second chassis movable relative to the first chassis; and
moving means for moving the first chassis relative to the second chassis;
the moving means comprising first and second connecting members, each connecting member connecting one side of the first chassis with an opposite side of the second chassis, and each connecting member being pivotable relative to the first chassis or the second chassis to allow the first chassis to move relative to the second chassis in a first direction about a point on a first side of the second chassis and in a second direction about a point on a second side of the second chassis.

2. The vehicle of claim 1, wherein each connecting member is configured to be pivotable only relative to a respective one of the first chassis or the second chassis when the first chassis moves in the first direction or the second direction.

3. The vehicle of claim 1, wherein the first connecting member connects a first side of the first chassis to the second side of the second chassis opposite the first side of the first chassis; and
wherein the second connecting member connects a second side of the first chassis to the first side of the second chassis opposite the second side of the first chassis.

4. The vehicle of claim 1, wherein the connecting members are each disposed generally transversely between the first chassis and the second chassis with respect to a direction of travel along a straight path.

5. The vehicle of claim 1, wherein the first connecting member is disposed above the second connecting member.

6. The vehicle of claim 1, wherein the first connecting member is disposed below the second connecting member.

7. The vehicle of claim 1, wherein the connecting members are non-extendable elongate members.

8. The vehicle of claim 1, wherein the connecting members are pivotably connected to the first and second chassis by kingpins.

9. The vehicle of claim 8, wherein the first connecting member is pivotable about a first kingpin adjacent the second side of the second chassis to allow the first chassis to rotate about the first kingpin and move in the second direction relative to the second chassis; and
wherein the second connecting member is pivotable about a second kingpin adjacent the first side of the second chassis to allow the first chassis to rotate about the second kingpin and move in the first direction relative to the second chassis.

10. The vehicle of claim 1, wherein the moving means further comprises actuating means for moving the first chassis relative to the second chassis.

11. The vehicle of claim 10, wherein the actuating means is configured for changing the angle between the first and second chassis to thereby steer the vehicle.

12. The vehicle of claim 9, wherein hydraulic cylinders are used to push and/or pull the first chassis relative to the second chassis to change the angle therebetween.

13. The vehicle of claim 9, wherein a first hydraulic cylinder is located between a first side of the first chassis and the first side of the second chassis and a second hydraulic cylinder is located between a second side of the first chassis and the second side of the second chassis to thereby move the first chassis relative to the second chassis.

14. The vehicle of claim 13, wherein the first and second hydraulic cylinders are double acting hydraulic cylinders.

15. A vehicle comprising:
a first chassis;
a second chassis movable relative to the first chassis; and
moving means for moving the first chassis relative to the second chassis;
the moving means comprising first and second connecting members, each connecting member connecting one side of the first chassis with an opposite side of the second chassis, and each connecting member being pivotable relative to the first or second chassis to allow the first chassis to move relative to the second chassis.

16. The vehicle of claim 15, wherein the first connecting member is pivotable about a first point adjacent one side of the second chassis to allow the first chassis to rotate about the first point and move in one direction relative to the second chassis; and
wherein the second connecting member is pivotable about a second point adjacent an opposite side of the second chassis to allow the first chassis to rotate about the second point and move in an opposite direction relative to the second chassis.

17. A mechanism for assisting the steering of a vehicle assembly, the vehicle assembly including a first chassis and a second chassis, the mechanism comprising
a first connection member for connecting a first side of the first chassis with a second side of the second chassis opposite the first side of the first chassis; and
a second connecting member for connecting a second side of the first chassis with a first side of the second chassis opposite the first side of the first chassis;
each connecting member being pivotable relative to the first or second chassis to allow the first chassis to move relative to the second chassis.

18. The mechanism of claim 17, wherein the connection members are connected to the first and second chassis by kingpins.

19. The mechanism of claim 18, wherein the kingpins are low friction kingpins.

20. The mechanism of claim 18, further comprising one or more bearings configured to assist movement of the connection members about the kingpins.

21. The mechanism of claim 17, wherein the connecting members are non-extendable elongate members.

22. The mechanism of claim 17, wherein the first connecting member is disposed above the second connecting member.
